(19) United States
(12) Patent Application Publication
(10) Pub. No.: US 2025/0327999 A1
(43) Pub. Date: Oct. 23, 2025

(54) OPTICAL SCANNING APPARATUS, METHOD FOR CONTROLLING THE SAME, AND PROGRAM

(71) Applicant: CANON KABUSHIKI KAISHA, Tokyo (JP)

(72) Inventors: YUKIO FURUKAWA, Kanagawa (JP); KOICHI SUZUKI, Kanagawa (JP); RYOTA OTSUBO, Tokyo (JP)

(21) Appl. No.: 19/257,076

(22) Filed: Jul. 1, 2025

Related U.S. Application Data
(63) Continuation of application No. PCT/JP2023/045332, filed on Dec. 18, 2023.

(30) Foreign Application Priority Data
Jan. 6, 2023 (JP) 2023-001283

(51) Int. Cl. G02B 21/00; G02B 21/36

(52) U.S. Cl. CPC G02B 21/0036; G02B 21/0076; G02B 21/362

(57) ABSTRACT

An optical scanning apparatus configured to scan light over a substrate containing spots includes: an irradiation optical unit configured to irradiate the substrate with primary light emitted from a semiconductor laser (LD); a photosensor configured to detect light from the substrate irradiated with the primary light as secondary light; a first scanning unit configured to move the irradiation optical unit relative to the substrate in the X-direction using a piston-crank mechanism; a second scanning unit configured to move the substrate relative to the irradiation optical unit in the Y-direction intersecting the X-direction; and a control unit configured to control an output timing of the primary light emitted from the semiconductor laser (LD) and an acquisition timing of detection information of the secondary light detected by the photosensor based on positional information of the irradiation optical unit.

### CROSS-REFERENCE TO RELATED APPLICATIONS

This application is a Continuation of International Patent Application No. PCT/JP2023/045332, filed Dec. 18, 2023, which claims the benefit of Japanese Patent Application No. 2023-001283, filed Jan. 6, 2023, both of which are hereby incorporated by reference herein in their entirety.

### BACKGROUND

### Field of the Technology

The present disclosure relates to an optical scanning apparatus that scans light over a substrate containing spots, a method for the same, and a program.

### Description of the Related Art

A protein array plate or a peptide array plate has been known to have a large number of biomolecules immobilized thereon, the biomolecules having peptide bonds such as proteins or peptides on a substrate. Using these plates allows simultaneous interaction with a large number of biomolecules immobilized on the substrate. Such array plates are effective in exhaustively analyzing the interaction between a liquid specimen, for example, blood, cell extract, saliva, and intercellular fluid, and a large number of proteins or peptides. Such analysis allows measurement of the properties of a specimen. Hereinafter, immobilized portions of proteins or peptides on the substrate are referred to as “spots”.

A known example of a method for observing spots that are subjected to interaction with a specimen is a method for determining which spots are subjected to interaction by labeling the spots with fluorescent probes. A microarray scanner is known as an apparatus for observing an array plate labelled with fluorescent probes.

US Patent Application No. 2009/0218513 discloses a microarray scanner including an irradiation optical system, a fluorescence detection optical system, and a two-dimensional scanning system. The irradiation optical system has a function of focusing laser light and irradiating the array plate with the laser light. The fluorescence detection optical system has a function of detecting the amount of fluorescence emitted from spots labeled by fluorescent probes. Specifically, a confocal optical system is employed as the fluorescence detection optical system. The two-dimensional scanning system has a function of acquiring a fluorescence image of spots on the array plate by two-dimensionally scanning the array plate or the optical system. Specifically, the two-dimensional scanning system employs a piston-crank mechanism in one of the two-dimensional scanning operations.

Japanese Patent Laid-Open No. 2007-183313 discloses a technique for irradiating a specimen serving as a substrate while scanning, at a constant speed, laser light having different wavelengths for forward and reverse paths when acquiring a fluorescence image.

In the scanning process using the piston-crank mechanism disclosed in US Patent Application No. 2009/0218513, slight unintended distortion may occur in the scanning target during scanning, such as lateral displacement, or rotational misalignment in pitch, yaw, or roll directions. Since the direction of stress applied to the scanning target is reversed between forward and reverse scanning operations, the above-described distortion exhibits different behaviors between the forward and reverse scanning operations. In this respect, in US Patent Application No. 2009/0218513, distortion occurring during forward and reverse scanning operations is superimposed on the fluorescence image, resulting in a problem in which the fluorescence image becomes distorted.

In the technique disclosed in Japanese Patent Laid-Open No. 2007-183313, irradiation light is scanned across the substrate at a constant speed, and therefore, the technique cannot accommodate scanning using the piston-crank mechanism in which the scanning speed varies depending on the scanning position.

### SUMMARY

The present disclosure is directed to provide a mechanism for acquiring an image with reduced distortion (for example, a fluorescence image) when scanning light across a substrate using a piston-crank mechanism.

According to a first aspect of the present disclosure, an optical scanning apparatus configured to scan light over a substrate containing spots is provided which includes: an irradiation optical unit configured to irradiate the substrate with primary light emitted from a light source; a detection unit configured to detect light from the substrate irradiated with the primary light as secondary light; a first scanning unit configured to move the irradiation optical unit relative to the substrate in a first direction using a piston-crank mechanism; a second scanning unit configured to move the substrate relative to the irradiation optical unit in a second direction intersecting the first direction; and a control unit configured to control an output timing of the primary light emitted from the light source and an acquisition timing of detection information of the secondary light detected by the detection unit based on positional information of the irradiation optical unit.

The present disclosure according to a second aspect provides a method for controlling the optical scanning apparatus. The present disclosure according to a third aspect provides a computer program for causing a computer to carry out the control method.

Features of the present disclosure will become apparent from the following description of embodiments with reference to the attached drawings.

### BRIEF DESCRIPTION OF THE DRAWINGS

FIG. 1 is a diagram illustrating, in outline, an example of the configuration of an optical scanning apparatus according to an embodiment of the present disclosure.

FIG. 2 is a diagram illustrating a substrate in FIG. 1 viewed from the front surface.

FIG. 3 is a diagram of a first embodiment of the present disclosure, illustrating, in outline, part of the configuration of the optical scanning apparatus in FIG. 1.

FIG. 4 is a timing chart illustrating an example of a method for controlling the optical scanning apparatus according to the first embodiment of the present disclosure.

FIG. 5 is a diagram of a second embodiment of the present disclosure, illustrating, in outline, part of the configuration of the optical scanning apparatus in FIG. 1.

FIG. 6 is a timing chart illustrating an example of a method for controlling the optical scanning apparatus according to the second embodiment of the present disclosure.

### DESCRIPTION OF THE EMBODIMENTS

Embodiments of the present disclosure will be described hereinbelow with reference to the drawings.

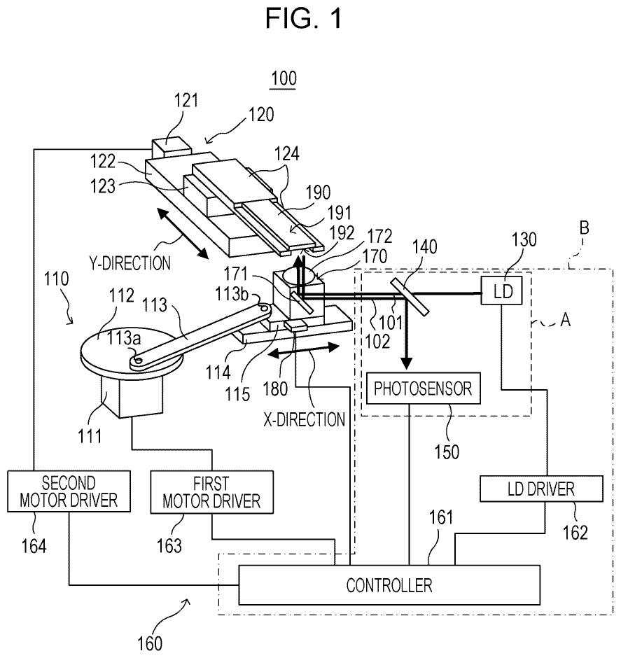

FIG. 1 is a diagram illustrating, in outline, an example of the configuration of an optical scanning apparatus 100 according to an embodiment of the present disclosure. The optical scanning apparatus 100 illustrated in FIG. 1 is an apparatus that scans light over a substrate 190 containing spots. As illustrated in FIG. 1, the optical scanning apparatus 100 incudes a first scanning unit 110, a second scanning unit 120, a semiconductor laser (LD) 130, a half mirror 140, a photosensor 150, a control unit 160, an irradiation optical unit 170, an encoder 180, and a substrate 190. The control unit 160 includes a controller 161, an LD driver 162, a first motor driver 163, and a second motor driver 164.

The semiconductor laser (LD) 130 is a light source that emits primary light 101 toward the substrate 190. Specifically, the semiconductor laser (LD) 130 emits the primary light 101 from the back surface 192 of the substrate 190 via the half mirror 140 and the irradiation optical unit 170. In the example illustrated in FIG. 1, the semiconductor laser (LD) is used as a light source for emitting the primary light 101; alternatively, a light-emitting diode (LED) may be used.

The first scanning unit 110 includes a motor 111, a disc 112, a connecting rod 113, a linear guide 114, and an X-direction mobile stage 115. The motor 111 is a motor that rotates the disc 112 serving as a rotary member under the control of the first motor driver 163. The disc 112 is a rotary member rotated by the motor 111. The connecting rod 113 is a member that converts the rotary motion of the disc 112 serving as a rotary member to a reciprocal motion (a linear motion) in the X-direction (a first direction) of the irradiation optical unit 170 illustrated in FIG. 1. The connecting rod 113 is connected to the disc 112 at one end 113a, and connected to the X-direction mobile stage 115 at the other end 113b to which the irradiation optical unit 170 is fixed. In the present embodiment, the motor 111, the disc 112, and the connecting rod 113 constitute the piston-crank mechanism. The linear guide 114 is disposed in the X-direction (the first direction). The X-direction mobile stage 115 is a movable member to which the irradiation optical unit 170 is fixed at a predetermined position and which is moved by the piston-crank mechanism back and forth in the X-direction (the first direction) along the linear guide 114. The first scanning unit 110 can move the irradiation optical unit 170 in the X-direction (the first direction), thereby allowing the primary light 101 to be scanned over the substrate 190 in the X-direction (the first direction). In the present embodiment, the first scanning unit 110 is configured to move the irradiation optical unit 170 relative to the substrate 190 in the X-direction (the first direction) using the piston-crank mechanism. The disc 112 includes the connecting portion (one end) 113a rotatable with respect to the connecting rod 113 at a position radially separate from the rotation center. The disc 112 may be referred to as a crank 112. The connecting rod 113 may be referred to as a coupling rod 113 or a con′rod 113. The linear guide 114 and the X-direction mobile stage 115 are configured to convert the rotary motion of the disc 112 to a linear motion via the connecting rod 113 and may be referred to as a piston mechanism. The piston-crank mechanism constituted by the disc 112, the connecting rod 113, the linear guide 114, and the X-direction mobile stage 115 may be referred to as a crank mechanism.

The second scanning unit 120 includes a motor 121, a linear guide 122, a Y-direction movable rack 123, and a mount 124. The mount 124 is configured such that the substrate 190 containing spots can be placed at a predetermined position. Specifically, in the present embodiment, the mount 124 has an opening at the position where the substrate 190 is to be placed so that the primary light 101 can be applied from the back surface 192 of the substrate 190. The motor 121 is configured to move the Y-direction movable rack 123, which is a movable member, in the Y-direction (a second direction), illustrated in FIG. 1, under the control of the second motor driver 164. Here, in the present embodiment, the Y-direction (the second direction) is a direction intersecting (preferably, perpendicular to) the X-direction (the first direction). The linear guide 122 is disposed in the Y-direction (the second direction). The Y-direction movable rack 123 is a movable member to which the mount 124 is fixed at a predetermined position and which is moved by the motor 121 back and forth in the Y-direction (the second direction) along the linear guide 122. Since the scanning in the Y-direction (the second direction) requires high accuracy, it is preferable that the motor 121 be, for example, a pulse motor. The second scanning unit 120 can move the substrate 190 in the Y-direction (the second direction), thereby allowing the primary light 101 to be scanned over the substrate 190 in the Y-direction (the second direction). In the present embodiment, the second scanning unit 120 is configured to move the substrate 190 relative to the irradiation optical unit 170 in the Y-direction (the second direction) intersecting the X-direction (the first direction).

The irradiation optical unit 170 is configured to apply the primary light 101 emitted from the semiconductor laser (LD) 130 serving as a light source to the substrate 190. The irradiation optical unit 170 includes a 90° mirror 171 and an objective lens 172. The irradiation optical unit 170 is disposed so that the primary light 101 is focused onto a surface of the substrate 190 containing spots (in the present embodiment, a front surface 191). The irradiation optical unit 170 receives secondary light 102 from the substrate 190 irradiated with the primary light 101 and outputs the secondary light 102 toward the half mirror 140 and the photosensor 150. The secondary light 102 is generated from the focus of the primary light 101 formed on the substrate 190 and includes information on the spots or the substrate 190. The secondary light 102 includes reflected light of the primary light 101, generated from the substrate 190, and fluorescence generated from the spots and the substrate 190 due to the irradiation with the primary light 101.

The half mirror 140 allows the primary light 101 emitted from the semiconductor laser (LD) 130 serving as a light source to pass through and outputs it to the irradiation optical unit 170 and reflects the secondary light 102 incident on the substrate 190 via the irradiation optical unit 170 and outputs it to the photosensor 150.

The photosensor 150 is a detection unit configured to detect the secondary light 102 from the substrate 190, incident via the irradiation optical unit 170 and the half mirror 140. In other words, the photosensor 150 detects the light from the substrate 190, incident thereon via the irradiation optical unit 170, as the secondary light 102. Application examples of the photosensor 150 include a photodiode and a photomultiplier tube.

The encoder 180 is configured to acquire information on the position of the irradiation optical unit 170. In the example illustrated in FIG. 1, the encoder 180 is mounted on the X-direction mobile stage 115 and can acquire the information on the position of the irradiation optical unit 170 by acquiring the positional information of the X-direction mobile stage 115. In the example illustrated in FIG. 1, the encoder 180 is disposed at the linear motion side of the first scanning unit 110, but may be disposed on the rotary motion side of the first scanning unit 110 to acquire the rotational angle information of the motor 111. In this case, the information on the position of the irradiation optical unit 170 can be acquired from the radius of the disc 112 and the length of the connecting rod 113 using the rotational angle information of the motor 111.

As described above, the control unit 160 includes the controller 161, the LD driver 162, the first motor driver 163, and the second motor driver 164. The control unit 160 controls the output timing at which the primary light 101 is emitted from the semiconductor laser (LD) 130 serving as a light source and the acquisition timing at which information on the secondary light 102 detected by the photosensor 150 serving as a detection unit is acquired, based on the information on the position of the irradiation optical unit 170. In the present embodiment, specifically, the control unit 160 controls the output timing of the primary light 101 and the acquisition timing of the detection information of the secondary light 102 based on the information on the position of the irradiation optical unit 170 acquired by the encoder 180. The controller 161 controls the LD driver 162, the first motor driver 163, and the second motor driver 164 and acquires the information from the encoder 180 and the photosensor 150. The LD driver 162 controls the semiconductor laser (LD) 130 under the control of the controller 161. The first motor driver 163 controls the motor 111 under the control of the controller 161. The second motor driver 164 controls the motor 121 under the control of the controller 161.

The controller 161 acquires the information on the position of the irradiation optical unit 170 from the encoder 180. When the irradiation optical unit 170 reaches a primary light 101 emission start position, the controller 161 controls the LD driver 162 to start emission of the primary light 101 by the semiconductor laser (LD) 130. Thereafter, the controller 161 acquires the detection information of the secondary light 102 by the photosensor 150 at regular distance intervals from the timing at which the irradiation optical unit 170 reaches a detection start position. When the irradiation optical unit 170 reaches an emission end position of the primary light 101, the controller 161 controls the LD driver 162 to stop the emission of the primary light 101 by the semiconductor laser (LD) 130. The timing at which the emission of the primary light 101 is terminated need not be based on the information of the encoder 180; instead, a timing after a predetermined time has elapsed from the start of emission of the primary light 101. In either case, the timing of the start of emission of the primary light 101 need only be before the timing of the start of detection of the secondary light 102, and the timing of the end of the emission of the primary light 101 need only be after the timing of the end of the detection of the secondary light 102.

Here, in the first scanning unit 110 illustrated in FIG. 1, the movement of the X-direction mobile stage 115 from right to left in the X-direction (the first direction) is defined as forward scanning, and the reverse movement from left to right in the X-direction (the first direction) is defined as reverse scanning. In the scanning by the first scanning unit 110 using the piston-crank mechanism, the direction of stress applied to the X-direction mobile stage 115 is opposite between the forward scanning and reverse scanning in the X-direction (the first direction). For this reason, the distortion of the X-direction mobile stage 115 (lateral displacement, or rotational misalignment in pitch, yaw, or roll directions) due to the stress applied thereto exhibits different behaviors between the forward and reverse scanning operations. The distortion of the X-direction mobile stage 115 exhibits a periodic behavior in synchronization with the rotation of the motor 111 to displace the focal position of the primary light 101, causing distortion in the acquired two-dimensional image. For this reason, in the present embodiment, in one of forward scanning and reverse scanning operations (for example, in the forward scanning operation), the information of the secondary light 102 detected by the photosensor 150 is acquired, and in the other scanning operation (for example, in the reverse scanning operation), the information of the secondary light 102 detected by the photosensor 150 is not acquired. This configuration eliminates the influence of the distortion of the X-direction mobile stage 115 generated during the reverse scanning operation on a two-dimensional image. The distortion of the X-direction mobile stage 115 generated during the forward scanning operation exerts an influence on a two-dimensional image. However, the distortion is substantially constant in each scanning in synchronization with the rotation of the motor 111, thereby reducing an influence on the two-dimensional image. Furthermore, for example, the amount of distortion on the two-dimensional image generated in each scanning is measured in advance, and stored as the amount of correction. By correcting the two-dimensional image acquired based on the detection information of the secondary light 102 detected by the photosensor 150 using the stored correction amount, the influence on the two-dimensional image can be further reduced. If the color of the spots to be measured is faded by light irradiation, it is preferable not to emit the primary light 101 during reverse scanning in which no detection information is acquired from the photosensor 150. For this reason, it is preferable to set the timing to stop the emission of the primary light 101 before the timing at which the scanning switches from forward canning to reverse scanning.

It is preferable that the second scanning unit 120 scan in the Y-direction (the second direction) intersecting the X-direction (the first direction), which is the scanning direction of the first scanning unit 110, so as not to exert an influence on the two-dimensional image. For example, it is preferable that scanning in the Y-direction (the second direction) by the second scanning unit 120 be executed during a period outside the timing from the start to the end of detection of the secondary light 102 by the photosensor 150. Alternatively, the scanning of the substrate 190 in the Y-direction (the second direction) by the second scanning unit 120 may be performed at a constant speed regardless of the operation of the first scanning unit 110. In this case, the resulting two-dimensional image takes the form of a parallelogram slightly skewed with respect to an actual rectangle in the Y-direction (the second direction), which is the scanning direction of the second scanning unit 120.

However, only a deviation comparable to the scanning pitch (for example, 10 μm) in the Y-direction (the second direction), which is the scanning direction of the second scanning unit 120, occurs at both ends in the X-direction (the first direction), which is the scanning direction of the first scanning unit 110. Accordingly, the deviation is not visually perceptible and has little practical impact.

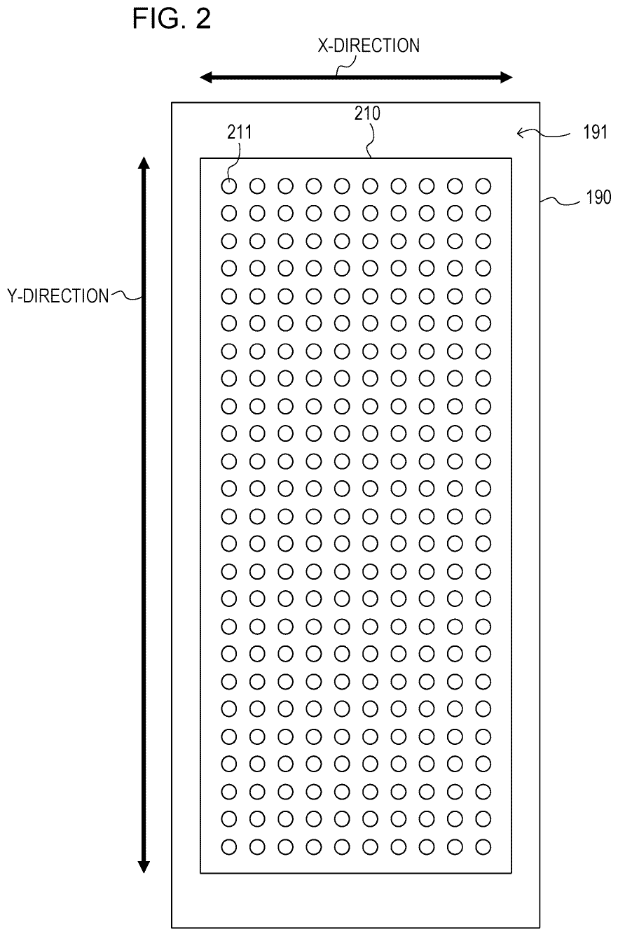

The substrate 190 includes a plurality of arrayed spots on one surface. In other words, the substrate 190 is a substrate having a plurality of spots arrayed on one surface. FIG. 2 is a diagram illustrating the substrate 190 in FIG. 1 viewed from the front surface 191. As illustrated in FIG. 2, the substrate 190 includes a rectangular glass slide having short sides and long sides and a large number of spots 211 arrayed on the front surface 191. The substrate 190 includes an area 210 having the spots 211 and an area having no spots 211, for example, for reasons related to production of the spots 211 or to user's convenience in holding the substrate 190. The individual spots 211 have immobilized thereon biomolecules containing peptide bonds, such as proteins or peptides. Here, a single spot 211 has one kind of biomolecule immobilized thereon. Each spot 211 comprises the biomolecule immobilized on the substrate 190 such that it contacts when a fluid specimen (for example, a biologically-derived liquid specimen, such as blood, cell extract, saliva, or intercellular fluid) is supplied onto the substrate 190. The primary light 101 is incident on the back surface 192 of the substrate 190, passes through the glass slide, and focuses on the front surface 191 of the substrate 190 illustrated in FIG. 2. In the present embodiment, as illustrated in FIG. 2, the short side of the substrate 190 corresponds to the X-direction (the first direction) in FIG. 1, and the long side of the substrate 190 corresponds to the Y-direction (the second direction) in FIG. 1. In the present embodiment, the X-direction (the first direction) corresponds to the main scanning direction of the primary light 101, and the Y-direction (the second direction) corresponds to the sub-scanning direction of the primary light 101.

### First Embodiment

Next, a first specific embodiment of the present disclosure will be described. In the following description of the first embodiment, explanation of elements common to the above-described embodiment of the present disclosure will be omitted, and only differences from the above embodiment of the present disclosure will be described.

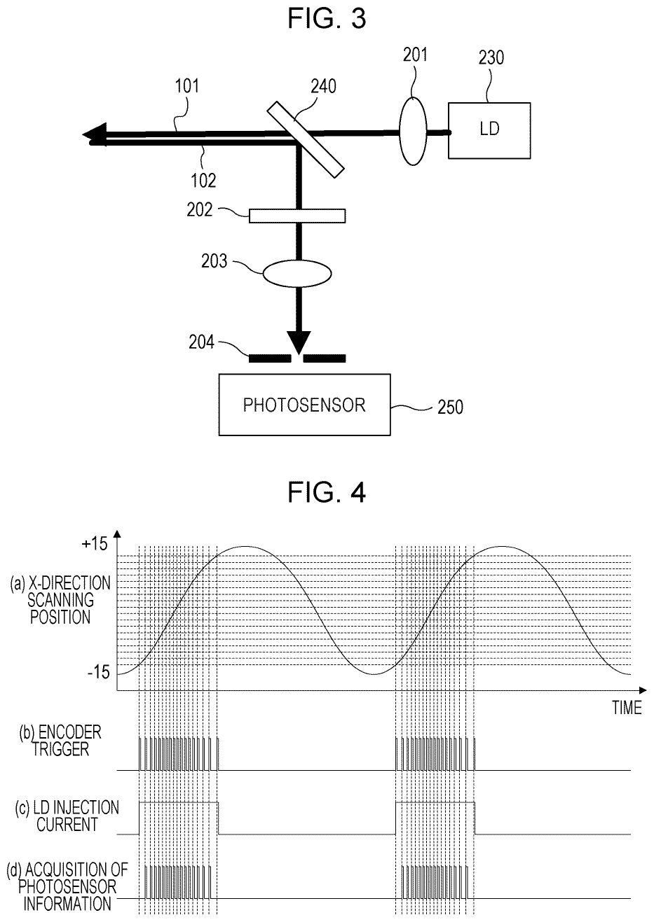

FIG. 3 is a diagram of the first embodiment of the present disclosure, illustrating, in outline, part of the configuration of the optical scanning apparatus 100 in FIG. 1. Specifically, FIG. 3 illustrates an alternative configuration example of an area A of the schematic configuration of the optical scanning apparatus 100 illustrated in FIG. 1. Specifically, in FIG. 3, a semiconductor laser (LD) 230, a short pass filter 240, and a photosensor 250 are applied instead of the semiconductor laser (LD) 130, the half mirror 140, and the photosensor 150, respectively, in the area A illustrated in FIG. 1. In FIG. 3, a collimate lens 201, a band pass filter 202, a condensing lens 203, and a pin-hole 204 are additionally provided in the area A illustrated in FIG. 1.

The semiconductor laser (LD) 230 illustrated in FIG. 3 emits laser light having a wavelength of 785 nm and an output of 10 mW as the primary light 101. This primary light 101 is converted to parallel light by the collimate lens 201, and passes through the short pass filter 240 having a cut-off wavelength of 800 nm. The primary light 101 transmitted through the short pass filter 240 irradiates the substrate 190 via the irradiation optical unit 170 illustrated in FIG. 1.

Light from the substrate 190 irradiated with the primary light 101 passes through the short pass filter 240, the band pass filter 202, the condensing lens 203, and the pin-hole 204, and is detected as the secondary light 102 by the photosensor 250. The secondary light 102 is, for example, fluorescence at the spots or the substrate 190, generated from the focus of the primary light 101 formed on the front surface 191 of the substrate 190 irradiated with the primary light 101. Specifically, the secondary light 102 is reflected by the short pass filter 240, passes through the band pass filter 202 having a predetermined transmission band of 805 to 840 nm, and is focused onto the pin-hole 204 by the condensing lens 203. The photosensor 250 is constituted of, for example, a photomultiplier tube, so as to detect the feeble secondary light 102.

FIG. 4 is a timing chart illustrating an example of a method for controlling the optical scanning apparatus 100 according to the first embodiment of the present disclosure.

FIG. 4-(a) illustrates the position of the first scanning unit 110 illustrated in FIG. 1 in the X-direction (the first direction), which is the scanning direction, on the X-direction mobile stage 115. In FIG. 4, the horizontal axis indicates time. The radius of rotation of the connecting portion (113a) between the disc 112 and the connecting rod 113 is set to 15 mm, and the distance between the connecting portions 113a and 113b of the connecting rod 113 is set to 100 mm. In this case, the X-direction mobile stage 115 moves in the X-direction within a range from −15 to +15 mm. Here, the side of the X-direction mobile stage 115 that is closer to the disc 112 is defined as the positive X-direction, and scanning in the positive X-direction is defined as forward scanning. The side of the X-direction mobile stage 115 that is farther from the disc 112 is defined as the negative X-direction, and scanning in the negative X-direction is defined as reverse scanning. As illustrated in FIG. 4-(a), the position of the X-direction mobile stage 115 in the X-direction (the first direction) with respect to time exhibits a substantially sinusoidal waveform. In the foregoing description, FIG. 4-(a) illustrates the position of the X-direction mobile stage 115 in the X-direction (the first direction); however, this is illustrative only in the first embodiment. Since the irradiation optical unit 170 is fixed to a predetermined position of the X-direction mobile stage 115, it is construed in the first embodiment that FIG. 4-(a) illustrates the position of the irradiation optical unit 170 in the X-direction (the first direction).

FIG. 4-(b) illustrates trigger information generated by the encoder 180. The encoder 180 generates the trigger information in accordance with the X-direction scanning position of the X-direction mobile stage 115, for example, within a range from −14 to +14 mm at a 10 μm pitch. Alternatively, the encoder 180 may generate the trigger information at a pitch finer than 10 μm, and the trigger information may be converted by the controller 161 to trigger information with a 10 μm pitch.

FIG. 4-(c) illustrates the timing at which the controller 161 illustrated in FIG. 1 injects a current into the semiconductor laser (LD) 230 via the LD driver 162. Specifically, in FIG. 4-(c), the controller 161 starts to inject a current to the semiconductor laser (LD) 230 (starts emission of the primary light 101) in accordance with trigger information generated when the X-direction mobile stage 115 is at an X-direction scanning position of −14 mm. In FIG. 4-(c), the controller 161 ends the injection of the current to the semiconductor laser (LD) 230 (terminates emission of the primary light 101) in accordance with trigger information generated when the X-direction mobile stage 115 is at an X-direction scanning position of +14 mm. In the first embodiment, the timing at which the primary light 101 is emitted from the semiconductor laser (LD) 230 includes at least one of the start time and the end time of emitting the primary light 101.

FIG. 4-(d) illustrates the timing at which the controller 161 acquires detection information from the photosensor 250. For example, the controller 161 starts to acquire the detection information from the photosensor 250 in accordance with trigger information generated when the X-direction mobile stage 115 is at an X-direction scanning position of −13 mm. Thereafter, the controller 161 continues to acquire the detection information from the photosensor 250 in accordance with trigger information generated at a 10 μm pitch of the X-direction scanning position, illustrated in FIG. 4-(a). Then, the controller 161 ends the acquisition of the detection information from the photosensor 250 in accordance with trigger information generated when the X-direction mobile stage 115 is at an X-direction scanning position of +13 mm. In the first embodiment, the timing of acquiring the detection information of the secondary light 102 includes at least one of the start time and the end time of acquiring the detection information of the secondary light 102. In the first embodiment, the start time of emitting the primary light 101 is before the start time of acquiring the detection information of the secondary light 102. In the first embodiment, the controller 161 of the control unit 160 controls the timing of acquiring the detection information of the secondary light 102 so that the acquisition of the detection information of the secondary light 102 is executed in the X-direction (the first direction) at predetermined distance intervals.

Scanning by the second scanning unit 120 in the Y-direction (the second direction) intersecting the X-direction (the first direction), which is the scanning direction of the first scanning unit 110, is performed, for example, in such a manner that the second scanning unit 120 moves by 10 μm, while the X-direction mobile stage 115 is moving on the reverse path. By repeating this scanning, the second scanning unit 120 scans a desired range (for example, from Y=5 mm to Y=65 mm) of the substrate 190.

As described above, in the optical scanning apparatus 100 according to first embodiment of the present disclosure, the irradiation optical unit 170 applies the primary light 101 emitted from the semiconductor laser (LD) 230 serving as a light source to the substrate 190 containing spots. The photosensor 250 detects the light from the substrate 190 irradiated with the primary light 101 as the secondary light 102. The first scanning unit 110 moves the irradiation optical unit 170 relative to the substrate 190 in the X-direction (the first direction) using the piston-crank mechanism. The second scanning unit 120 moves the substrate 190 relative to the irradiation optical unit 170 in the Y-direction (the second direction) intersecting the X-direction (the first direction). The control unit 160 performs control of the semiconductor laser (LD) 230, illustrated in FIG. 4-(c), and control of the photosensor 250, illustrated in FIG. 4-(d), based on the information on the X-direction scanning position of the X-direction mobile stage 115 (that is, the position of the irradiation optical unit 170), illustrated in FIG. 4-(a). Specifically, the control unit 160 controls the output timing of the primary light 101 by the semiconductor laser (LD) 230 and the acquisition timing of the detection information of the secondary light 102 detected by the photosensor 250 based on the information on the position of the irradiation optical unit 170.

According to this configuration, it is possible to acquire an image with reduced distortion (for example, a fluorescence image) when scanning light over the substrate 190 using the piston-crank mechanism. Specifically, in the first embodiment, a two-dimensional fluorescence image with reduced image distortion 26 mm in the X-direction, 60 mm in the Y-direction, and with a pixel pitch of 10 μm. When some of the spots included in the substrate 190 interact with the specimen, and the interacted spots contain a fluorescence substance that emits fluorescence in response to light having a wavelength of 785 nm, the specimen information distribution of the front surface 191 of the substrate 190 can be acquired as fluorescence information.

### Second Embodiment

Next, a second specific embodiment of the present disclosure will be described. In the following description of the second embodiment, explanation of elements common to the above-described embodiment and the first embodiment of the present disclosure will be omitted, and only differences from the above embodiment and the first embodiment of the present disclosure will be described.

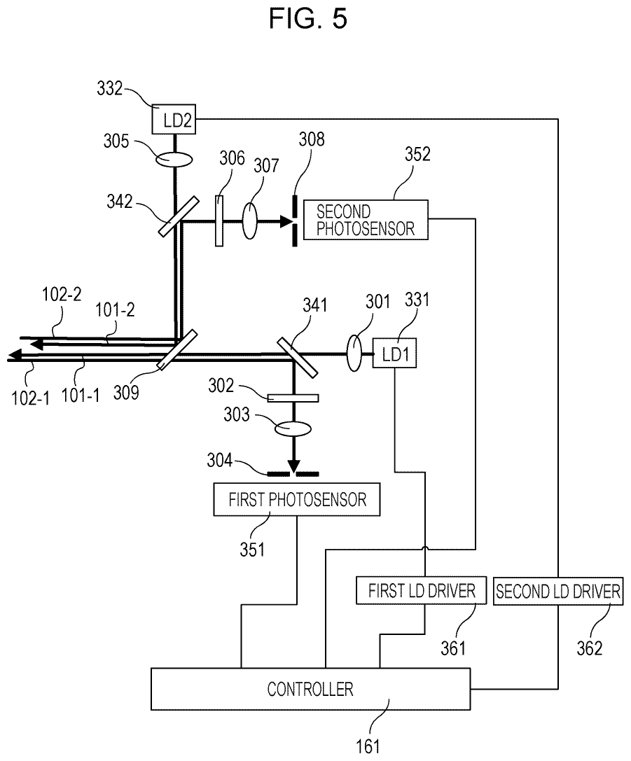

FIG. 5 is a diagram of the second embodiment of the present disclosure, illustrating, in outline, part of the configuration of the optical scanning apparatus 100 in FIG. 1. Specifically, FIG. 5 illustrates an alternative configuration example of an area B of the schematic configuration of the optical scanning apparatus 100 illustrated in FIG. 1. Components having the same configuration as those illustrated in FIG. 1 are denoted by the same reference signs, and detailed descriptions thereof are omitted. The optical scanning apparatus 100 according to the second embodiment irradiates the substrate 190 with primary lights 101-1 and 101-2 having different wavelengths and detects light from the substrate 190 corresponding to the primary lights 101-1 and 101-2 as secondary lights 102-1 and 102-2, respectively.

Specifically, in FIG. 5, a first semiconductor laser (LD1) 331 and a second semiconductor laser (LD2) 332 are applied, instead of the semiconductor laser (LD) 130, in the area B illustrated in FIG. 1.

In FIG. 5, a first short pass filter 341 and a second short pass filter 342 area applied, instead of the half mirror 140, in the area B illustrated in FIG. 1. In FIG. 5, a first photosensor 351 and a second photosensor 352 area are applied, instead of the photosensor 150, in the area B illustrated in FIG. 1. In FIG. 5, a first LD driver 361 and a second LD driver 362 are applied, instead of the LD driver 162, in the area B illustrated in FIG. 1. In FIG. 5, a first collimate lens 301, a second collimate lens 305, a first band pass filter 302, and a second band pass filter 306 are added in the area B illustrated in FIG. 1. Furthermore, in FIG. 5, a first condensing lens 303, a second condensing lens 307, a first pin-hole 304, a second pin-hole 308, and a long pass filter 309 are added in the area B illustrated in FIG. 1.

The first semiconductor laser 331 illustrated in FIG. 5 is a first light source that emits laser light having a wavelength of 785 nm (a first wavelength) and an output of 10 mW as the first primary light 101-1. This first primary light 101-1 is converted to parallel light by the first collimate lens 301 and passes through the first short pass filter 341 having a cut-off wavelength of 800 nm. The first primary light 101-1 that has passed through the first short pass filter 341 further passes through the long pass filter 309 having a cut-on wavelength of 750 nm and irradiates the substrate 190 via the irradiation optical unit 170 illustrated in FIG. 1.

Light from the substrate 190 irradiated with the first primary light 101-1 (the primary light 101 having a wavelength of 785 nm) is detected as the first secondary light 102-1 by the first photosensor 351. In this case, the first secondary light 102-1 is, for example, fluorescence at the spots or the substrate 190, generated from the focus of the first primary light 101-1 formed on the front surface 191 of the substrate 190 irradiated with the first primary light 101-1. Specifically, the first secondary light 102-1 passes through the long pass filter 309 and is reflected by the first short pass filter 341. Thereafter, the first secondary light 102-1 passes through the first band pass filter 302 having a predetermined transmission band of 800 to 840 nm, and is focused onto the first pin-hole 304 by the first condensing lens 303. The first photosensor 351 is constituted of, for example, a photomultiplier tube, so as to detect the feeble first secondary light 102-1.

The second semiconductor laser 332 illustrated in FIG. 5 is a second light source that emits laser light having a wavelength of 670 nm (a second wavelength) and an output of 10 mW as the second primary light 101-2. This second primary light 101-2 is converted to parallel light by the second collimate lens 305 and passes through the second short pass filter 342 having a cut-off wavelength of 680 nm. The second primary light 101-2 that has passed through the second short pass filter 342 is reflected by the long pass filter 309 and irradiates the substrate 190 via the irradiation optical unit 170 illustrated in FIG. 1.

Light from the substrate 190 irradiated with the second primary light 101-2 (the primary light 101 having a wavelength of 670 nm) is detected as the second secondary light 102-2 by the second photosensor 352. In this case, the second secondary light 102-2 is, for example, fluorescence at the spots or the substrate 190, generated from the focus of the second primary light 101-2 formed on the front surface 191 of the substrate 190 irradiated with the second primary light 101-2. Specifically, the second secondary light 102-2 is reflected by the long pass filter 309 and then reflected by the second short pass filter 342. Thereafter, the second secondary light 102-2 passes through the second band pass filter 306 having a predetermined transmission band of 690 to 730 nm, and is focused onto the second pin-hole 308 by the second condensing lens 307. The second photosensor 352 is constituted of, for example, a photomultiplier tube, so as to detect the feeble second secondary light 102-2.

In the second embodiment, the control unit 160 includes the controller 161, the first LD driver 361, the second LD driver 362, the first motor driver 163, and the second motor driver 164. In the second embodiment, the control unit 160 controls the output timing of the first primary light 101-1 emitted from the first semiconductor laser 331 and the output timing of the second primary light 101-2 emitted from the second semiconductor laser 332 based on the information on the position of the irradiation optical unit 170. In the second embodiment, the control unit 160 also controls the acquisition timing of the detection information of the first secondary light 102-1 and the second secondary light 102-2 detected by the first and second photosensors 351 and 352 serving as detection units, respectively, based on the information on the position of the irradiation optical unit 170. In the second embodiment, the controller 161 controls the first LD driver 361, the second LD driver 362, the first motor driver 163, and the second motor driver 164. In the second embodiment, the controller 161 acquires information from the encoder 180, the first photosensor 351, and the second photosensor 352. The first LD driver 361 controls the first semiconductor laser 331 under the control of the controller 161. The second LD driver 362 controls the second semiconductor laser 332 under the control of the controller 161.

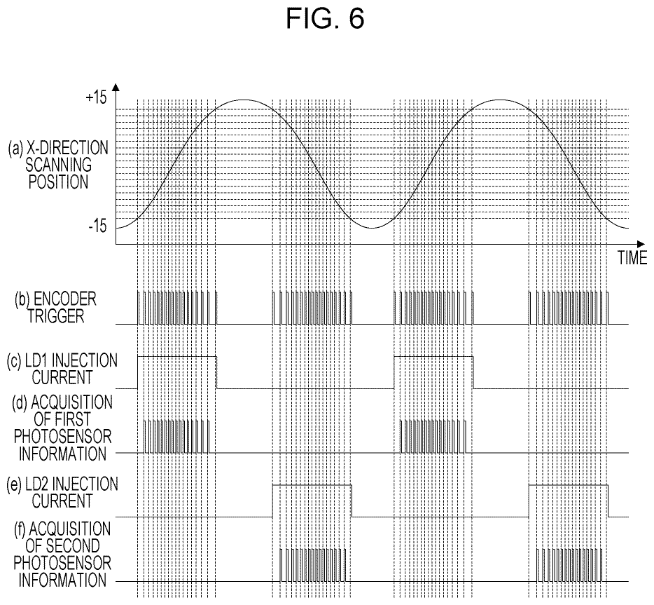

FIG. 6 is a timing chart illustrating an example of a method for controlling the optical scanning apparatus 100 according to the second embodiment of the present disclosure.

FIG. 6-(a) illustrates the position of the first scanning unit 110 illustrated in FIG. 1 in the X-direction (the first direction), which is the scanning direction, on the X-direction mobile stage 115. In FIG. 6, the horizontal axis indicates time. The radius of rotation of the connecting portion (113a) between the disc 112 and the connecting rod 113 is set to 15 mm, and the distance between the connecting portions 113a and 113b of the connecting rod 113 is set to 100 mm. In this case, the X-direction mobile stage 115 moves in the X-direction within a range from −15 to +15 mm. Here, the side of the X-direction mobile stage 115 that is closer to the disc 112 is defined as the positive X-direction, and scanning in the positive X-direction is defined as forward scanning. The side of the X-direction mobile stage 115 that is farther from the disc 112 is defined as the negative X-direction, and scanning in the negative X-direction is defined as reverse scanning. As illustrated in FIG. 6-(a), the position of the X-direction mobile stage 115 in the X-direction (the first direction) with respect to time exhibits a substantially sinusoidal waveform. In the foregoing description, FIG. 6-(a) illustrates the position of the X-direction mobile stage 115 in the X-direction (the first direction); however, this is illustrative only in the second embodiment. Since the irradiation optical unit 170 is fixed to a predetermined position of the X-direction mobile stage 115, it is construed in the second embodiment that FIG. 6-(a) illustrates the position of the irradiation optical unit 170 in the X-direction (the first direction).

FIG. 6-(b) illustrates trigger information generated by the encoder 180. The encoder 180 generates the trigger information in accordance with the X-direction scanning position of the X-direction mobile stage 115, for example, within a range from −14 to +14 mm on the forward path and within a range from +14 to −14 mm on the reverse path at a 10 μm pitch. Alternatively, the encoder 180 may generate the trigger information at a pitch finer than 10 μm, and the trigger information may be converted by the controller 161 to trigger information with a 10 μm pitch. In the second embodiment illustrated in FIG. 6-(b), unlike in the first embodiment illustrated in FIG. 4-(b), the trigger information generated by the encoder 180 is acquired not only during forward scanning but also during reverse scanning.

FIG. 6-(c) illustrates the timing at which the controller 161 illustrated in FIG. 5 injects a current into the first semiconductor laser (LD) 331 via the first LD driver 361. Specifically, in FIG. 6-(c), the controller 161 starts to inject a current to the first semiconductor laser (LD) 331 (starts emission of the first primary light 101-1) in accordance with trigger information generated when the X-direction mobile stage 115 is at an X-direction scanning position of −14 mm. In FIG. 6-(c), the controller 161 ends the injection of the current to the first semiconductor laser (LD) 331 (terminates the emission of the first primary light 101-1) in accordance with trigger information generated when the X-direction mobile stage 115 is at an X-direction scanning position of +14 mm.

FIG. 6-(d) illustrates the timing at which the controller 161 acquires detection information from the first photosensor 351. For example, the controller 161 starts to acquire the detection information from the first photosensor 351 in accordance with trigger information generated when the X-direction mobile stage 115 is at an X-direction scanning position of −13 mm. Thereafter, the controller 161 continues to acquire the detection information from the first photosensor 351 in accordance with trigger information generated at a 10 μm pitch of the X-direction scanning position, illustrated in FIG. 6-(a). Then, the controller 161 ends the acquisition of the detection information from the first photosensor 351 in accordance with trigger information generated when the X-direction mobile stage 115 is at an X-direction scanning position of +13 mm.

FIG. 6-(e) illustrates the timing at which the controller 161 illustrated in FIG. 5 injects a current into the second semiconductor laser (LD) 332 via the second LD driver 362. Specifically, in FIG. 6-(e), the controller 161 starts to inject a current to the second semiconductor laser (LD) 332 (starts emission of the second primary light 101-2) in accordance with trigger information generated when the X-direction mobile stage 115 is at an X-direction scanning position of +14 mm. In FIG. 6-(e), the controller 161 ends the injection of the current to the second semiconductor laser (LD) 332 (terminates the emission of the second primary light 101-2) in accordance with trigger information generated when the X-direction mobile stage 115 is at an X-direction scanning position of −14 mm.

FIG. 6-(f) illustrates the timing at which the controller 161 acquires detection information from the second photosensor 352. For example, the controller 161 starts to acquire the detection information from the second photosensor 352 in accordance with trigger information generated when the X-direction mobile stage 115 is at an X-direction scanning position of +13 mm. Thereafter, the controller 161 continues to acquire the detection information from the second photosensor 352 in accordance with trigger information generated at a 10 μm pitch of the X-direction scanning position, illustrated in FIG. 6-(a). Then, the controller 161 ends the acquisition of the detection information from the second photosensor 352 in accordance with trigger information generated when the X-direction mobile stage 115 is at an X-direction scanning position of −13 mm.

It is preferable that the scanning by the second scanning unit 120 in the Y-direction intersecting the X-direction, which is the scanning direction of the first scanning unit 110, be executed during a period excluding the interval between the start timing and the end timing of acquiring the detection information of the secondary lights 102-1 and 102-2. For example, the scanning by the second scanning unit 120 in the Y-direction is performed in such a manner that the second scanning unit 120 moves, for example, by 10 μm, after completion of the acquisition of the detection information of the secondary light 102 during reverse scanning by the first scanning unit 120 in the X-direction and before the start of the acquisition of the detection information of the secondary light 102 during forward scanning. By repeating this scanning, the second scanning unit 120 scans a desired range (for example, from Y=5 mm to Y=65 mm) of the substrate 190.

As described above, the optical scanning apparatus 100 according to the second embodiment of the present disclosure has the following configuration. The first semiconductor laser 331 serving as the first light source emits the first primary light 101-1 including the first wavelength when the irradiation optical unit 170 is moved to one side in the X-direction (the first direction) by the first scanning unit 110. The second semiconductor laser 332 serving as the second light source emits the second primary light 101-2 including the second wavelength different from the first wavelength when the irradiation optical unit 170 is moved by the first scanning unit 110 in another direction different from the one direction in the X-direction. The first photosensor 351 and the second photosensor 352 serving as detection units detect the first secondary light 102-1 based on the first primary light 101-1 and the second secondary light 102-2 based on the second primary light 101-1. The control unit 160 controls the output timing of the first primary light 101-1 and the output timing of the second primary light 101-2 based on the scanning position in the X-direction of the X-direction mobile stage 115 (that is, the position of the irradiation optical unit 170) illustrated in FIG. 6-(a). The control unit 160 also controls the acquisition timing of the detection information of the first secondary light 102-1 and the acquisition timing of the detection information of the second secondary light 102-2 based on the scanning position in the X-direction of the X-direction mobile stage 115 (that is, the position of the irradiation optical unit 170) illustrated in FIG. 6-(a).

According to this configuration, when the substrate 190 is scanned with light using a piston-crank mechanism, an image with reduced distortion (for example, a fluorescence image) can be acquired. Specifically, in the second embodiment, two two-dimensional fluorescence images (two wavelengths) with reduced distortion, for example, 26 mm in the X-direction, 60 mm in the Y-direction, and a pixel pitch of 10 μm, can be acquired. Furthermore, when one substance in a spot contained in the substrate 190 is labeled with a fluorescence substance that emits fluorescence in response to light having a wavelength of 785 nm, and another substance in another spot is labeled with a fluorescence substance that emits fluorescence in response to light having a wavelength of 670 nm, the distribution of the two substances in the spots can be obtained as fluorescence information.

In the second embodiment, trigger information generated when the X-direction mobile stage 115 is at the same position both during forward scanning and reverse scanning in the X-direction is acquired. This allows the X-coordinate of the fluorescence image obtained with the first wavelength can be made substantially coincident with the X-coordinate of the fluorescence image obtained with the second wavelength.

When an electric delay occurs in the encoder 180, the photosensor 351 or 352, or the controller 161, forward scanning and reverse scanning in the X-direction deviate in opposite directions, resulting in an increased X-coordinate deviation between the fluorescence image obtained with the first wavelength and the fluorescence image obtained with the second wavelength. For this reason, in the second embodiment, the control unit 160 controls the acquisition timings of the detection information of the secondary lights 102-1 and 102-2 so that the detection position of the substrate 190 using the first secondary light 102-1 and the detection position of the substrate 190 using the second secondary light 102-2 fall within a predetermined error range. When the control unit 160 controls the acquisition timings so that acquisition of the detection information of the secondary lights 102-1 and 102-2 is executed at a predetermined distance interval in the X-direction, the predetermined error range falls within one half or less of the predetermined distance interval. By setting the predetermined error range in this manner, the X-coordinate deviation between the fluorescence image obtained with the first wavelength and the fluorescence image obtained with the second wavelength poses substantially no problems. The amount of X-coordinate deviation between a fluorescence image obtained with the first wavelength and a fluorescence image obtained with the second wavelength due to such an electric delay may be measured in advance as a correction amount, and two different two-dimensional fluorescence images may be corrected using the correction value.

In the second embodiment, while one primary light 101-1 (primary light 101-2) is being emitted, the other primary light 101-2 (the primary light 101-1) is not emitted. This has the advantage that no inter-wavelength crosstalk occurs, as compared with a case where the primary lights are emitted simultaneously. In general, the shorter the wavelength, the higher the light energy. For this reason, it is preferable to repeat irradiation/detection of long-wavelength light, irradiation/detection of short-wavelength light, and Y-direction scanning in this order in consideration of color fading of a fluorescence substance due to light. If the color fading does not need to be taken into consideration, the order may be different.

### OTHER EMBODIMENTS

The present disclosure may also be realized by supplying a program that implements one or more of the functions described above to a system or device via a network or storage medium, and having one or more processors in the computer of the system or device read and execute the program. It may also be realized by a circuit (e.g., ASIC) that implements one or more of the functions.

This program and the computer-readable storage medium storing the program are included in the present disclosure.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

The embodiments of the present disclosure include the following configurations, method, and program.

### Configuration 1

An optical scanning apparatus configured to scan light over a substrate containing spots, the apparatus comprising:
an irradiation optical unit configured to irradiate the substrate with primary light emitted from a light source;
a detection unit configured to detect light from the substrate irradiated with the primary light as secondary light;
a first scanning unit configured to move the irradiation optical unit relative to the substrate in a first direction using a piston-crank mechanism;
a second scanning unit configured to move the substrate relative to the irradiation optical unit in a second direction intersecting the first direction; and
a control unit configured to control an output timing of the primary light emitted from the light source and an acquisition timing of detection information of the secondary light detected by the detection unit based on positional information of the irradiation optical unit.

### Configuration 2

The optical scanning apparatus according to Configuration 1, further comprising:
an encoder configured to obtain the positional information of the irradiation optical unit.
wherein the control unit controls the output timing and the acquisition timing based on the positional information of the irradiation optical unit obtained by the encoder.

### Configuration 3

The optical scanning apparatus according to Configuration 1 or 2,
wherein the piston-crank mechanism includes:
   a motor configured to rotate a rotary member; and
   a connecting rod configured to convert a rotary motion of the rotary member to a reciprocal motion of the irradiation optical unit in the first direction.

### Configuration 4

The optical scanning apparatus according to Configuration 3, wherein the connecting rod is connected at one end to the rotary member and at another end to a moving member to which the irradiation optical unit is fixed.

### Configuration 5

The optical scanning apparatus according to any one of Configurations 1 to 4, wherein the output timing includes at least one of a start time and an end time of outputting the primary light.

### Configuration 6

The optical scanning apparatus according to any one of Configurations 1 to 5, wherein the acquisition timing includes at least one of a start time and an end time of acquiring the detection information of the secondary light.

### Configuration 7

The optical scanning apparatus according to any one of Configurations 1 to 6,
wherein the output timing includes the start time of outputting the primary light,
wherein the acquisition timing includes the start time of acquiring the detection information of the secondary light, and
wherein the start time of outputting the primary light is before the start time of acquiring the detection information of the secondary light.

### Configuration 8

The optical scanning apparatus according to any one of Configurations 1 to 7, wherein the control unit controls the acquisition timing in such a way that the detection information of the secondary light is acquired at predetermined distance intervals in the first direction.

### Configuration 9

The optical scanning apparatus according to any one of Configurations 1 to 8,
wherein the primary light comprises first primary light having a first wavelength and second primary light having a second wavelength different from the first wavelength;
wherein the light source includes:
   a first light source configured to emit the first primary light when the irradiation optical unit is moved by the first scanning unit to one side in the first direction; and
   a second light source configured to emit the second primary light when the irradiation optical unit is moved by the first scanning unit to another side opposite to the one side in the first direction,
wherein the secondary light comprises first secondary light based on the first primary light and second secondary light based on the second primary light,
wherein the detection unit detects the first secondary light and the second secondary light, and
wherein the control unit controls, based on the positional information of the irradiation optical unit, output timing of the first primary light and output timing of the second primary light and acquisition timing of detection information of the first secondary light detected by the detection unit and acquisition timing of detection information of the second secondary light detected by the detection unit.

### Configuration 10

The optical scanning apparatus according to Configuration 9, wherein the control unit controls the acquisition timing of the detection information of the first secondary light and the acquisition timing of the detection information of the second secondary light in such a manner that a detection position of the substrate obtained using the first secondary light and a detection position of the substrate obtained using the second secondary light fall within a predetermined error range.

### Configuration 11

The optical scanning apparatus according to Configuration 10,
wherein the control unit controls the acquisition timing of the detection information of the first secondary light and the acquisition timing of the detection information of the second secondary light in such a manner that the detection information of the first secondary light and the detection information of the second secondary light are acquired at a predetermined distance interval in the first direction, and
wherein the predetermined error range is equal to or less than one half of the predetermined distance interval.

### Configuration 12

The optical scanning apparatus according to any one of Configurations 1 to 11, wherein the detection unit detects light, originating from the substrate and incident through the irradiation optical unit, as the secondary light.

### Method 1

A method for controlling an optical scanning apparatus configured to scan light over a substrate containing spots, the method comprising:
irradiating the substrate with primary light emitted from a light source via an irradiation optical unit;
detecting light from the substrate irradiated with the primary light as secondary light using a detection unit;
moving the irradiation optical unit relative to the substrate in a first direction using a piston-crank mechanism;
moving the substrate relative to the irradiation optical unit in a second direction intersecting the first direction; and
controlling an output timing of the primary light emitted from the light source and an acquisition timing of detection information of the secondary light detected by the detection unit based on positional information of the irradiation optical unit.

### Program 1

A computer program comprising instructions which, when the program is executed by a computer, cause the computer to carry out the method of Method 1.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An optical scanning apparatus configured to scan light over a substrate containing spots, the apparatus comprising:
an irradiation optical unit configured to irradiate the substrate with primary light emitted from a light source;
a detection unit configured to detect light from the substrate irradiated with the primary light as secondary light;
a first scanning unit configured to move the irradiation optical unit relative to the substrate in a first direction using a piston-crank mechanism;
a second scanning unit configured to move the substrate relative to the irradiation optical unit in a second direction intersecting the first direction; and
a control unit configured to control an output timing of the primary light emitted from the light source and an acquisition timing of detection information of the secondary light detected by the detection unit based on positional information of the irradiation optical unit.

2. The optical scanning apparatus according to claim 1, further comprising:
an encoder configured to obtain the positional information of the irradiation optical unit,
wherein the control unit controls the output timing and the acquisition timing based on the positional information of the irradiation optical unit obtained by the encoder.

3. The optical scanning apparatus according to claim 1,
wherein the piston-crank mechanism includes:
a motor configured to rotate a rotary member; and
a connecting rod configured to convert a rotary motion of the rotary member to a reciprocal motion of the irradiation optical unit in the first direction.

4. The optical scanning apparatus according to claim 3, wherein the connecting rod is connected at one end to the rotary member and at another end to a moving member to which the irradiation optical unit is fixed.

5. The optical scanning apparatus according to claim 1, wherein the output timing includes at least one of a start time and an end time of outputting the primary light.

6. The optical scanning apparatus according to claim 1, wherein the acquisition timing includes at least one of a start time and an end time of acquiring the detection information of the secondary light.

7. The optical scanning apparatus according to claim 1, wherein the output timing includes the start time of outputting the primary light,
wherein the acquisition timing includes the start time of acquiring the detection information of the secondary light, and
wherein the start time of outputting the primary light is before the start time of acquiring the detection information of the secondary light.

8. The optical scanning apparatus according to claim 1, wherein the control unit controls the acquisition timing in such a way that the detection information of the secondary light is acquired at predetermined distance intervals in the first direction.

9. The optical scanning apparatus according to claim 1,
wherein the primary light comprises first primary light having a first wavelength and second primary light having a second wavelength different from the first wavelength;
wherein the light source includes:
a first light source configured to emit the first primary light when the irradiation optical unit is moved by the first scanning unit to one side in the first direction; and
a second light source configured to emit the second primary light when the irradiation optical unit is moved by the first scanning unit to another side opposite to the one side in the first direction,
wherein the secondary light comprises first secondary light based on the first primary light and second secondary light based on the second primary light,
wherein the detection unit detects the first secondary light and the second secondary light, and
wherein the control unit controls, based on the positional information of the irradiation optical unit, output timing of the first primary light and output timing of the second primary light and acquisition timing of detection information of the first secondary light detected by the detection unit and acquisition timing of detection information of the second secondary light detected by the detection unit.

10. The optical scanning apparatus according to claim 9, wherein the control unit controls the acquisition timing of the detection information of the first secondary light and the acquisition timing of the detection information of the second secondary light in such a manner that a detection position of the substrate obtained using the first secondary light and a detection position of the substrate obtained using the second secondary light fall within a predetermined error range.

11. The optical scanning apparatus according to claim 10,
wherein the control unit controls the acquisition timing of the detection information of the first secondary light and the acquisition timing of the detection information of the second secondary light in such a manner that the detection information of the first secondary light and the detection information of the second secondary light are acquired at a predetermined distance interval in the first direction, and
wherein the predetermined error range is equal to or less than one half of the predetermined distance interval.

12. The optical scanning apparatus according to claim 1, wherein the detection unit detects light, originating from the substrate and incident through the irradiation optical unit, as the secondary light.

13. A method for controlling an optical scanning apparatus configured to scan light over a substrate containing spots, the method comprising:
irradiating the substrate with primary light emitted from a light source via an irradiation optical unit;
detecting light from the substrate irradiated with the primary light as secondary light using a detection unit;
moving the irradiation optical unit relative to the substrate in a first direction using a piston-crank mechanism;
moving the substrate relative to the irradiation optical unit in a second direction intersecting the first direction; and
controlling an output timing of the primary light emitted from the light source and an acquisition timing of detection information of the secondary light detected by the detection unit based on positional information of the irradiation optical unit.

14. A computer program comprising instructions which, when the program is executed by a computer, cause the computer to carry out the method of claim 13.
